(19) United States
(12) Patent Application Publication
(10) Pub. No.: US 2014/0145385 A1
(43) Pub. Date: May 29, 2014

(54) DAMPER BEARING FOR SUPPORTING A CHASSIS COMPONENT ON A MOTOR VEHICLE BODY

(71) Applicant: Michael Barma, Bad Wünnenberg (DE)

(72) Inventor: Michael Barma, Bad Wünnenberg (DE)

(73) Assignee: AUDI AG, Ingolstadt (DE)

(21) Appl. No.: 13/883,195

(22) PCT Filed: Sep. 24, 2011
(86) PCT No.: PCT/EP2011/004788

§ 371 Date: Jul. 17, 2013

(30) Foreign Application Priority Data
Nov. 3, 2010 (DE) 10 2010 050 289.8

(51) Int. Cl. B60G 15/06; F16F 9/54

(52) U.S. Cl. CPC B60G 15/06; F16F 9/54
USPC 267/217

(57) ABSTRACT

A damper bearing for supporting a chassis component on a motor vehicle body includes a first bearing element for attachment to the vehicle body, a second bearing element for attachment to the chassis component, and a damping element which is arranged between the first and second bearing elements and which is composed of a shock-damping material. The first bearing element is formed as a disk spring—first disk spring—and the damping element has a disk-like basic shape, and the second bearing element is vulcanized into the disk-shaped damping element.

The invention relates to a damper bearing for supporting a chassis component on a motor vehicle body component according to the art described in the preamble of claim 1.

Many embodiments of such damper bearings are known in the art and are used, for example, in wheel suspensions of motor vehicles. They typically connect a shock absorber or a spring strut, which includes a shock absorber, with the body of the motor vehicle. The damper bearing is constructed to provide especially acoustic decoupling and damping in addition to the support function.

A generic damper bearing, which includes all features of the preamble of claim 1, is disclosed, for example, in DE 101 47 604 A1. However, the bearing disadvantageously requires a relatively large installation space and allows only a small gimbal offset.

It is therefore the object of the invention to improve a damper bearing for supporting a suspension component on a vehicle body according to the prior art cited in the preamble of claim 1 by eliminating the aforementioned disadvantages so that the bearing takes up less space and the gimbal offset is largely variable.

This object is attained by the characterizing features of claim 1 in conjunction with the features recited in the preamble.

The dependent claims recite advantageous embodiments of the invention.

In a known manner, the damper bearing for supporting a chassis component on a motor vehicle body includes a first bearing element by which the bearing is affixed on the vehicle body, and a second bearing element which is fixedly connected to the chassis component. A damping element made of a shock-absorbing material is arranged between the two bearing elements.

According to the invention, the first bearing element is embodied as a disk spring—first disk spring—, whereas the damping element has a disk-shaped basic shape into which the second bearing element is vulcanized.

Advantageously, a damper bearing is now provided, which has a small footprint and thus requires only a small installation space due to the use of the disk spring, the disk-shaped damping element, and because the second bearing element vulcanized in the disk-shaped damping element.

Preferably, the first disk spring and the second bearing element that is vulcanized into the disk-shaped damping element each have a central through-opening. This simplifies installation, because the two bearing elements can simply be pushed on the chassis component and the bearing can subsequently be screwed with a nut against a stop formed on the chassis component. This approach also guarantees quick disassembly in addition to quick assembly. In other words, the bearing or the first disk spring can be quickly exchanged, for example, during adjustment drives or tuning.

According to an embodiment of the invention, an additional third bearing element is disposed below the second support member, as viewed in the axial direction. The third bearing element is again formed as a disk spring—second disk spring—and has a central through-opening commensurate with the first and second bearing element. In this way, the axial stiffness of the bearing can advantageously be adjusted. In addition to using a second disk spring for adjusting and increasing the axial stiffness of the bearing, a different axial stiffness can also be adjusted by varying the sheet thickness and/or by varying the geometry and shape of the first and/or second disk spring.

Preferably, the second disk spring is cup-shaped. The cup-shaped configuration is advantageous for receiving, for example, a coil spring in a space-saving manner.

According to a particularly advantageous embodiment of the invention, the first disk spring and/or the second disk spring has radially outwardly extending slot-shaped recesses, as seen from the central through-opening. The formation of these slot-shaped recesses in the first and/or second disk spring creates a plurality of individual flexible springs. This advantageously enables a large gimbal displacement with low gimbal stiffness, because only some of the flexible springs are subjected to bending in a gimbal offset.

The cardanic stiffness can be adjusted through corresponding dimensioning/arrangement of the slot-shaped recesses. According to one embodiment, the slot-shaped recesses are distributed symmetrically around the periphery of the first and/or second disk spring. According to another embodiment, the slot-shaped recesses are arranged asymmetrically around the periphery of the first and/or second disk spring.

Further advantages, features and possible applications of the present invention will become apparent from the following description in conjunction with the exemplary embodiment illustrated in the drawings.

The invention will be described below with reference to the exemplary embodiment shown in the drawing.

The terms and associated reference characters used in the appended list of references are used in the description, in the claims and in the drawing.

The drawing shows in:

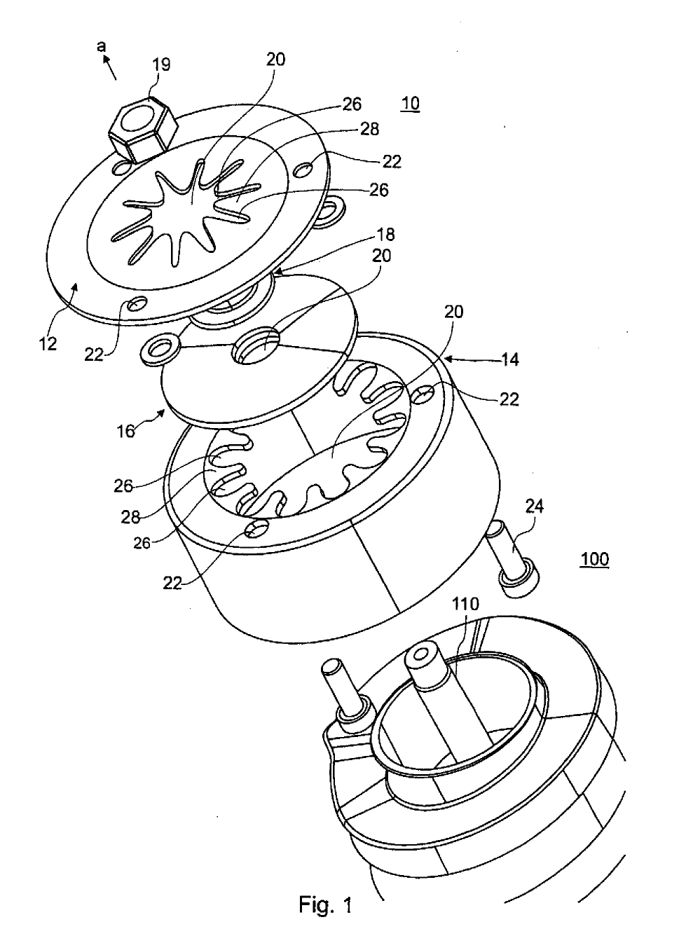

FIG. 1 an exploded view of the damper bearing according to the present invention, and

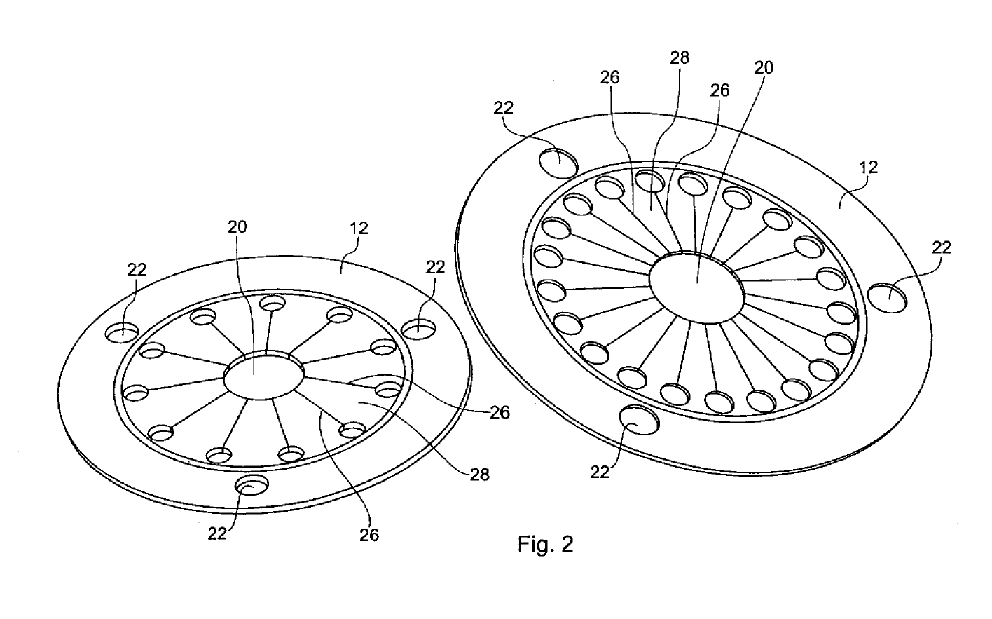

FIG. 2 a detailed view of the upper disk spring.

FIG. 1 shows more or less schematically an exploded view of a damper bearing generally designated by the reference numeral 10 and a damper module 100 generally designated by the reference numeral 100.

The damper bearing 10 includes an upper, first disk spring 12 and a lower second disk spring 14. A disk-shaped damping element 16 made of a shock absorbing material is arranged between the upper disk spring 12 and the lower disk spring 14. The lower, second disk spring 14 is provided with a cup housing, thus forming the support for the coil spring of the damper module 100.

Furthermore, the damper bearing 10 includes a second bearing element 18. The bearing 10 can be fastened to a piston rod 110 of the damper module 100 via the bearing element 18. The second bearing element 18 is visible only due to the exploded view; in the assembled state, the second bearing element 18 is vulcanized in the damping member 18.

As further shown in FIG. 1, the two disk springs 12, 14 as well as the second support member 18 which is vulcanized into the damping element 16 in the installed state each have a central through-opening 20, which allows the components 12, 14, 16 18 to be easily pushed against a stop formed on the piston rod 110 and to be screwed together by a nut 19.

For attachment to the vehicle body, which is not shown for sake of clarity, the upper disk spring 12 and the lower disk spring 14 have mutually aligned boreholes 22, by which they can be attached to the vehicle body with screws 24.

As can also be seen in FIG. 1, the upper disk spring 12 and the lower disk spring 14, respectively, have radially outwardly directed slot-shaped recesses 26, as viewed from the through-opening 20. The slot-shaped recesses 26 are uniformly distributed over the circumference of the disk spring and form in a plurality of flexible springs 28 the respective surface.

FIG. 2 shows a detailed view of two additional embodiments of the upper disk spring 12. In contrast to the embodiment shown in FIG. 1, the slot-shaped recesses 26 in these embodiments are narrower. The axial spring stiffness can be adjusted by selecting the number of the slot-shaped recesses 26 and/or the width of the slot-shaped recesses 26. This applies mutatis mutandis also to the second disk spring 14. In addition, the spring stiffness can be adjusted, for example, via a suitable choice of material and/or material thickness.

The operation of the damper bearing 10 will now be briefly explained: When the piston rod 110 moves in the axial direction a (compression), the second bearing element 16 in the damping element 18 is displaced upward. The damping element 16 is then sandwiched between the first disk spring 12 and the second bearing element 18 in the overlap region of the two components. When the shear stress in the damping element 16 becomes so large that the incompressible material can no longer yield, the flexural stiffness of the disk springs 12, 14 takes over the spring action. The disk springs 12, 14 bend uniformly upward under a concentric load and thus attain a very high stiffness. The dynamic driving requirement for making the gimbal offset as soft as possible is achieved because only a portion of the torsion springs 28 offers resistance with a gimbal offset, so that the bearing stiffness decreases significantly.

In a further development, the flexible spring may be eliminated, after the precise angle of the gimbal displacement has been determined in a multi-body simulation tool, such as MSC ADAMS. Sufficient radial and axial stiffness is then still available, with the positive side effect of the small gimbal stiffness.

The flexible springs do not overlap under tensile load of the piston rod (rebound). These forces are absorbed by the damping element 16, which is subjected to shear load in this load situation.

### LIST OF REFERENCE

10 damper bearing
12 first disk spring
14 second disk spring
16 damping element
18 second bearing element
19 nut
20 through-opening
22 borehole
24 screws
26 recess
28 bending spring
100 damper module
110 piston rod
a axial direction

What is claimed is:

1-7. (canceled)

8. A damper bearing for supporting a chassis component on a motor vehicle body, comprising:
a first bearing element formed as a first disk spring for attachment on the vehicle body, wherein the first disk spring has a central through-opening and slot-shaped recesses extending radially outwardly from the central through-opening;
a second bearing element for attachment on a suspension component, and
a disk-shaped damping element made of a shock-absorbing material and arranged between the first bearing element and second bearing element, wherein the second bearing element is vulcanized into the disk-shaped damping element.

9. The damper bearing of claim 8, wherein the second bearing element that is vulcanized into the disk-shaped damping element has a central through-opening.

10. The damper bearing of claim 8, further comprising a third bearing element formed as a second disk spring arranged below the second bearing element, as viewed in an axial direction, and having a central through-opening.

11. The damper bearing of claim 10, wherein the second disk spring is formed as a cup.

12. The damper bearing of claim 10, wherein the second disk spring has radially outwardly extending slot-shaped recesses starting from the central through-opening of the second disk spring.

13. The damper bearing of claim 8, wherein the slot-shaped recesses of the first disk spring are distributed symmetrically about a periphery of the first disk spring.

14. The damper bearing of claim 8, wherein the slot-shaped recesses of the first disk spring are distributed asymmetrically about a periphery of the first disk spring.

15. The damper bearing of claim 12, wherein the slot-shaped recesses of the second disk spring are distributed symmetrically about a periphery of the second disk spring.

16. The damper bearing of claim 12, wherein the slot-shaped recesses of the second disk spring are distributed asymmetrically about a periphery of the second disk spring.
